(19) United States
(12) Patent Application Publication
(10) Pub. No.: US 2010/0226428 A1
(43) Pub. Date: Sep. 9, 2010

(54) ENCODER AND DECODER CONFIGURATION FOR ADDRESSING LATENCY OF COMMUNICATIONS OVER A PACKET BASED NETWORK

(75) Inventors: Haresh Thevathasan, Milton (CA); Drew McDougall, Toronto (CA); Jiang Guo, Toronto (CA)

Correspondence Address: HAYNES AND BOONE, LLP;IP Section, 2323 Victory Avenue, Suite 700, Dallas, TX, 75219, US

(73) Assignee: TelePhoto Technologies Inc., Mississauga (CA)

(21) Appl. No.: 12/400,472

(22) Filed: Mar. 9, 2009

(51) Int. Cl. H04N 11/02

(52) U.S. Cl. 375/240.02; 375/240.01; 375/240.25; 375/E07.026

(57) ABSTRACT

An encoder for sending encoded video over a public packet-based communication network to a distribution server. The encoder comprises an encoder engine adapted for receiving video content and for encoding the received video content using a predefined encoding algorithm. The encoder also has a send buffer adapted for configuring the encoded content as an encoded video stream expressed as a plurality of packets for transmitting over the network, such that the send buffer has send buffer settings compatible with receive buffer settings associated with the distribution server, such that the distribution server is adapted for subsequent distribution of the encoded video stream over the network to a decoder having the algorithm for use in decoding of the encoded video stream, such that the socket configuration is between the send buffer of the encoder and the receive buffer of the distribution server.

### FIELD OF THE INVENTION

This invention relates to distribution of video content over a packet based communication networks.

### BACKGROUND OF THE INVENTION

There are many situations in which broadcast quality of live content is important, such as for viewing of live sporting events at betting/wagering facilities that are remote to the location of the live sporting event. An example of this required broadcast quality coordination between live sporting event facilities and remote betting/wagering facilities is in the horse racing industry. For example, industry figures indicate that of the total revenue a horse track receives, attendees physically at their track, betting on their live horse race, generate approximately ten percent. The remaining percent (e.g. ninety percent) can be generated from attendees at their track betting on simulcast races of other tracks as well as attendees at other tracks betting on their track. Often, track management will delay the start of live racing at their track in order that their racing does not coincide with races at other tracks. The goal in doing this is to increase their total revenue by increasing the opportunity for people to bet more—both on their track's races but also on races at other tracks that are simulcast at their track during the live racing. Accordingly, it is recognised that an important source of revenue for wagering on live sporting events is off track wagering, which relies upon acceptable video content and sequencing content of the live sporting event, as viewed at the remote betting facility.

Current off track facilities are equipped to receive simulcast signals of the live sporting events via satellite downlink from many Canadian and US live sporting venues (e.g. race tracks). Signal processing equipment deployed at each remote facility location, to create the television product and to receive and disseminate the satellite broadcast signals, can be very expensive due to bandwidth charges, equipment and/or licensing fees. For example, all the remote facilities need satellite dishes and receivers, which can make the costs of providing these services quite high. The remote facilities also need a subscription from a third party and a specialized decoder for each of video broadcasts they receive from each sporting venue (e.g. race track) from which the broadcast of the live sporting event is captured and then broadcast via satellite.

A further option is for the off track location to receive live sporting event broadcasts from non-satellite communication networks, e.g. the Internet. Real-time transmission of video content over shared networks with no QoS guarantees (e.g., the Internet) is increasingly becoming an important application area in multimedia communications. However, one hurdle in this area is maintaining appropriate encoding and continuous decoding and playback at the receiver despite severe network impairments such as high packet-loss-ratios, packet-delay-variations, and unbounded roundtrip delays. Therefore, in the case of live video content, certain packets of the communicated content (of the live sporting event) may be critical to understanding the outcome of the particular live sporting event taking place at the sporting venues. Accordingly, on a shared Internet network, undesirable packet switching and communication decisions made by the network, in view of other network traffic unrelated to the communicated content, can impact the communication quality of live content of the sporting venue(s). It is recognised that when traversing network nodes, packets can be buffered and queued, resulting in variable delay and throughput, depending on the traffic load in the network.

### SUMMARY

It is an advantage that the present invention may provide an encoder configuration to obviate and/or mitigate at least some of the above presented disadvantages.

It is an advantage that the present invention may provide a decoder configuration to obviate and/or mitigate at least some of the above presented disadvantages.

On a shared Internet network, undesirable packet switching and communication decisions made by the network, in view of other network traffic unrelated to the communicated content, can impact the communication quality of live content of the sporting venue(s). It is recognised that when traversing network nodes, packets can be buffered and queued, resulting in variable delay and throughput, depending on the traffic load in the network. Contrary to current systems, there is provided an encoder for sending encoded video over a public packet-based communication network to a distribution server. The encoder comprises an encoder engine adapted for receiving video content and adapted for encoding the received video content as an encoded video content using a predefined encoding algorithm. The encoder also has a send buffer adapted for configuring the encoded content as an encoded video stream expressed as a plurality of packets for transmitting over the network, such that the send buffer has send buffer settings compatible with receive buffer settings associated with the distribution server, such that the distribution server is adapted for subsequent distribution of the encoded video stream over the network to a decoder having the algorithm for use in decoding of the encoded video stream, such that the socket configuration is between the send buffer of the encoder and the receive buffer of the distribution server.

An aspect provided is an encoder for sending encoded video over a public packet-based communication network to a distribution server, the encoder comprising: an encoder engine adapted for receiving video content and adapted for encoding the received video content as an encoded video content using a predefined encoding algorithm; a send buffer adapted for configuring the encoded content as an encoded video stream expressed as a plurality of packets for transmitting over the network, the send buffer having send buffer settings compatible with receive buffer settings associated with the distribution server such that the distribution server is adapted for subsequent distribution of the encoded video stream over the network to a decoder having the algorithm for use in decoding of the encoded video stream such that the socket configuration is between the send buffer of the encoder and the receive buffer of the distribution server.

A further aspect is wherein the buffer settings of the buffers are selected from the group comprising: buffer sizing; and socket definitions and the buffer settings are for a (Transmission Control Protocol/Internet Protocol) TCP/IP communication protocol.

A further aspect provided is a method for sending encoded video over a public packet-based communication network to a distribution server, the method comprising instructions stored in a memory for execution by a computer processor, the instructions comprising: receiving video content and adapted for encoding the received video content as an encoded video content using a predefined encoding algorithm; and configuring the encoded content as an encoded video stream expressed as a plurality of packets for transmitting over the network, the send buffer having send buffer settings compatible with receive buffer settings associated with the distribution server such that the distribution server is adapted for subsequent distribution of the encoded video stream over the network to a decoder having the algorithm for use in decoding of the encoded video stream such that the socket configuration is between the send buffer of the encoder and the receive buffer of the distribution server.

A further aspect provided is a decoder for receiving encoded video over a public packet-based communication network from a distribution server, the decoder comprising: a receive buffer adapted for receiving the encoded content as an encoded video stream expressed as a plurality of packets, the receive buffer having receive buffer settings compatible with send buffer settings associated with the distribution server such that the distribution server is adapted for distribution of the encoded video stream over the network to the decoder having the algorithm for use in decoding of the encoded video stream, such that the socket configuration is between the receive buffer of the decoder and the send buffer of the distribution server; a decoder engine adapted decoding the received encoded video content as a decoded video content using a predefined decoding algorithm; and sending the decoded video stream to a display for viewing; wherein the origination of the encoded video stream is an encoder buffer coupled to a receive buffer of the distribution server.

A further aspect provided is a method for receiving encoded video over a public packet-based communication network from a distribution server, the method comprising instructions stored in a memory for execution by a computer processor, the instructions comprising: receiving the encoded content as an encoded video stream expressed as a plurality of packets, the receive buffer having receive buffer settings compatible with send buffer settings associated with the distribution server such that the distribution server is adapted for distribution of the encoded video stream over the network to the decoder having the algorithm for use in decoding of the encoded video stream, such that the socket configuration is between the receive buffer of the decoder and the send buffer of the distribution server; decoding the received encoded video content as a decoded video content using a predefined decoding algorithm; and sending the decoded video stream to a display for viewing; wherein the origination of the encoded video stream is an encoder buffer coupled to a receive buffer of the distribution server.

### BRIEF DESCRIPTION OF THE DRAWINGS

Exemplary embodiments of the invention will now be described in conjunction with the following drawings, by way of example only, in which:

FIG. 1 is a block diagram of components of video content distribution environment;

FIG. 2 shows an example configuration of the network entities of the environment of FIG. 1;

FIG. 3 is a block diagram of an example configuration buffers of the entities of FIG. 2;

FIG. 4a is an example connection diagram between entities of FIG. 2;

FIG. 4b is a further example connection diagram between entities of FIG. 2;

FIG. 5a is an example block diagram of the buffer connections of the encoder and distribution server of FIG. 2;

FIG. 5b is an example block diagram of the buffer connections of the decoder and distribution server of FIG. 2;

FIG. 6 are example definitions of the layers of the buffers of FIG. 2;

FIG. 7 is an example block diagram of a distribution server of FIG. 2;

FIG. 8 is a block diagram of an example computing device of the components/entities of the environment of FIG. 1;

FIG. 9 is an example workflow of the distribution server of FIG. 7;

FIG. 10 is an example workflow of the encoder of FIG. 7; and

FIG. 11 an example workflow of the decoder of FIG. 7.

### DETAILED DESCRIPTION OF PREFERRED EMBODIMENT(S) OF THE INVENTION

### Video Content Distribution Environment 10

It is recognised in the following description, it may be advantageous to set forth definitions of certain words and phrases used throughout this patent document, such as: the terms “include” and “comprise,” as well as derivatives thereof, mean inclusion without limitation; the term “or,” can be inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” or “module” or “processor” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### Overall Component Architecture of Network 11

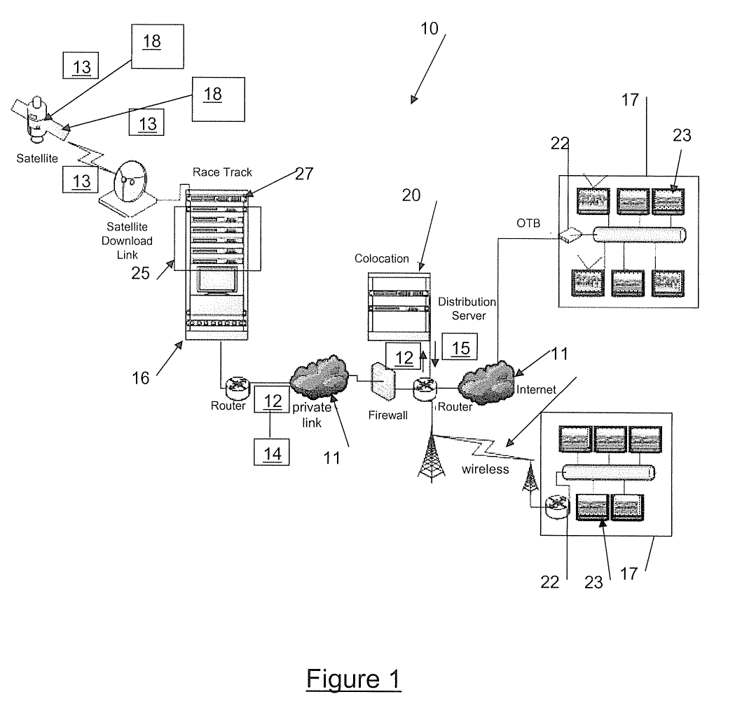

Referring to FIG. 1, a multimedia content distribution environment 10 is shown, used to facilitate the distribution of multimedia content 12 (e.g. video and audio) over a packet-based communications network 11, as an end-to-end transmission of streaming multimedia content 12 from a streaming video transmitter 16 through the data network 11 to one or more exemplary streaming video receivers 22. The multimedia content 12 includes captured video and audio 13 representing actions taking place in one or more live sporting events (e.g. horse racing, boxing, etc.), such actions occurring in real time at one or more sporting venues 18 (e.g. horse track, boxing arena, race track, etc.). Captured (e.g. via video production equipment located at the sporting venue(s) 18—not shown) content 13 of the live sporting events is/are communicated to the transmitter 16 for subsequent distribution over the network 11 as encoded content 12,15. It is recognised that the captured video and audio content 13 can be communicated directly from the sporting venue 18 to the transmitter or can be communicated indirectly via a satellite 21 and an intermediate satellite decoder 27 for recipient by a plurality of encoders 25 of the transmitter 16. It is recognised that the encoded content 12,15 is stream sized to be about 1 to 1.5 Mbps, for example, which is less that the stream size of the satellite signal 13. Streaming of video content 12,15 is implemented over the Internet 11, using selected stream 12,15 sizes configured via buffer settings of the network entities 18,25,20,22 while minimizing packet 14 losses that would not meet the facilities 17 viewing specifications. This reduction in stream size is preformed by the transmitter 18 and associated encoders 25, as further described below.

For example, current horse racing tracks transmit their video signals 13 to other sporting venues 18 and remote facilities 17 via television broadcast satellites 21. The satellite signal 13 is uplinked from the track 18 and each downlink site (e.g. remote facilities 17) must have a satellite dish aimed at the appropriate satellite 21 in question in order to receive the signal 13. In addition, most sporting venues 18 encode their signal 13 into an MPEG-2 stream for security to save precious space on existing satellite 21 transponders—this way multiple digital streams 13 can be broadcast on a single satellite 21 transponder. The size of this MPEG-2 stream is around 4.5 Mbps.

Referring again to FIG. 1, a distribution server 20 receives the communicated content 12 from the streaming video transmitter 16 and then creates duplicate streams 15, one for each of the respective video receivers 22. It is recognised that the distribution server 20 has knowledge of the compatibility of each of the respective video receivers 22 (e.g. decoders) with selected one(s) of the encoders of the streaming video transmitter 16. As such, the distribution server 20 is configured for matching the communicated content 12 of one of the encoders 25 with the correspondingly configured/compatible decoder (e.g. video receiver 22), such that the distribution server 20 receives the communicated content 12 from a respective encoder 25 and then directs/distributes the received communicated content 12 to the corresponding decoder(s) (e.g. video receiver 22) located at the remote facilities 17. In other words, the distribution server is configured to receive the communicated content 12 and then retransmit that, as content 15, to a plurality of corresponding decoder(s) that are compatible with the encoder 25 used to generate the received communicated content 12 (i.e. each decoder 22 is configured to decode the content 15 that is based on the encoded content 12 generated by the associated encoder 25).

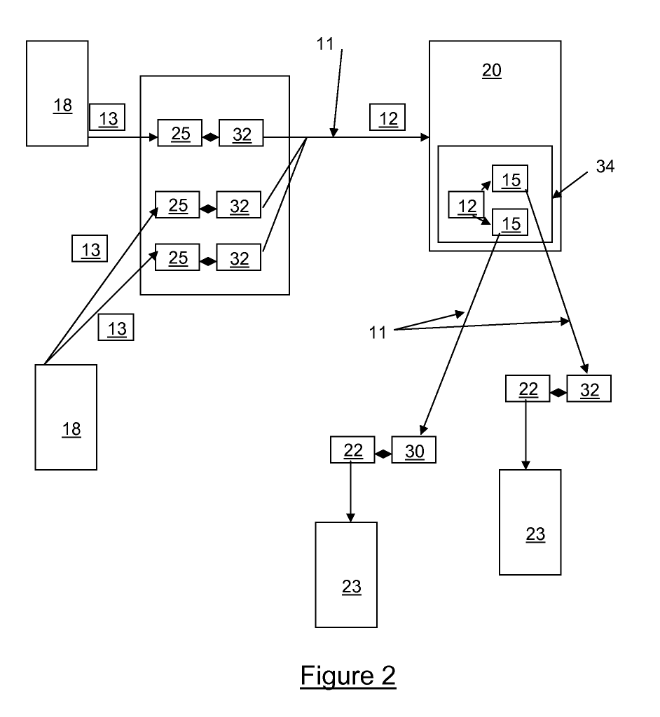

Referring again to FIG. 1, each of the video receivers 22 are positioned at facilities 17 located remotely (i.e. geographically) with respect to the sporting venue(s) 18. Accordingly, communication between the sporting venues 18 and the remote facilities 17 occurs over the network 11, for receipt and subsequent viewing of the multimedia content 12 on display(s) 23 of the remote facilities 17. One example of the remote facilities 17 are off track betting/wagering locations, at which bettors engage in betting activities based on the outcome of sporting action(s) occurring at the sporting venue(s) 18, in real time. For example, the allowable delay between capture of the sporting actions by the video production equipment of the sporting venues 18 and the resultant display of the captured sporting actions on the displays 23, is typically a predefined delay threshold (e.g. less than 10 seconds, less than 5 seconds, less than 3 s, etc.). Therefore, “real-time” viewing of the sporting event (occurring on location at the sporting venues 18) on the displays 23 is considered as viewing on the display(s) 23 of those sporting actions of the sporting event that have been delayed no more that the predefined delay threshold (i.e. the time delay between the sporting actions occurring and their subsequent viewing on the displays is less that the predefined delay threshold). The communication of the streaming content 12,15 over the network 11 is implemented by communication protocols (e.g. TCP/IP) used by buffers 30, 32, 34 (see FIG. 2) of the network entities/nodes (e.g. transmitter 16, distribution server 20, receivers 22), such that the streaming media content 12,15 is communicated as a series of packets 14 generated or otherwise manipulated in the buffers 30,32,34.

### Network 11

It is recognised that the network 11 is considered a non-guaranteed Quality-of-Service (QoS) network, e.g. the Internet, such that-to-end variations in the network (e.g., delay jitter) between the streaming video transmitter 16 and the streaming video receivers (e.g. distribution server 20 and/or the content decoders 22) mean that the end-to-end delay is not constant. Second, there is a packet 14 loss rate across non-QoS networks 11. The lost data packet(s) 14 of the content 12,15 are recovered or otherwise reordered (in the case of variable end-to-end communication delay of adjacent packets 14 of the content 12) prior to the time the corresponding frame is decoded. If not, an underflow event can occur at the decoder 22 level, which can impact the video quality of the sporting event playback shown on the displays 23 of the remote locations 17. Furthermore, if prediction-based compression is used, an underflow due to lost data packets 14 may not only impact the current frame being processed, but may affect many subsequent frames of the sporting event playback on the displays 23. It is recognised that in complex networks 11 constructed of multiple routing and switching nodes, the series of packets 14 sent from one host computer (e.g. the video transmitter 16 and/or the distribution server 20) to another (e.g. the distribution server 20 and/or the video receiver 22) may follow different routes over the network 11 to reach the same destination, by employing packet 14 switching as is known in the art. For example, the network 11 between the distribution server 20 and the decodes 22 can be a DSL (Digital Subscriber Line) network.

Referring again to FIG. 1, packet switching of the communicated content 12,15 over the network 11 is used to optimize the use of the channel capacity availability in digital telecommunication networks 11 (e.g. computer networks), to help minimize the transmission latency (i.e. the time it takes for data 12,15 to pass across the network 11), and to increase robustness of the communicated content 1215. However, it is recognised that in the case of live video content 12,15, certain packets 14 of the communicated content 12,15 may be critical to understanding the outcome of the particular live sporting event taking place at the sporting venues 18. Accordingly, on the shared network 11, undesirable packet 14 switching and communication decisions made by the network 11, in view of other network traffic unrelated to the communicated content 12,15, can impact the communication quality of live content of the sporting venue(s) 18.

Packet switching can be referred to as a network 11 communications method that groups all transmitted data of the content 12,15, irrespective of content, type, or structure into suitably-sized blocks (i.e. packets 14). The network 11 over which packets 14 are transmitted is considered a shared network 11 that routes each packet 14 independently from all other packets 14 (e.g. packets 14 from the same content 12,15 and/or packets 14 from different content 12,15) and allocates transmission resources of the network 11, as needed. It is recognised that principal goals of packet switching are to optimize utilization of available link capacity and to increase robustness of communicated contents 12,15 over the network 11.

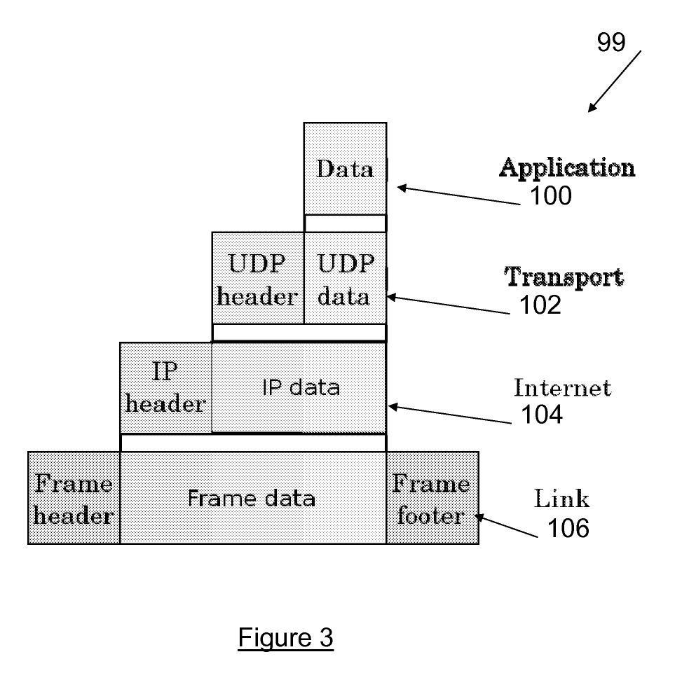

Examples of packet networks 11 can include networks such as but not limited to the Internet and other local area networks. The Internet uses the Internet protocol suite over a variety of Link Layer 106 (see FIG. 3) protocols, for example, Ethernet and frame relay. It is recognised that mobile phone networks 11 (e.g., GPRS, I-mode) can also use packet switching of the packets 14 of the communicated content 12,15. One example of packet switching methods is X.25, which provides virtual circuits to the user of the network 11. These virtual circuits can carry variable-length packets. Asynchronous Transfer Mode (ATM) method also is a virtual circuit technology, which uses fixed-length cell relay connection oriented packet switching of the packets 14 of the communicated content 12,15. Further, datagram packet 14 switching can be referred to as connectionless networking because no connections are established. Technologies such as Multiprotocol Label Switching (MPLS) and the Resource Reservation Protocol (RSVP) create virtual circuits on top of datagram networks 11. Virtual circuits can be useful in building robust failover mechanisms and allocating bandwidth for delay-sensitive applications, such as the live event content 12,15 communication over the network 11.

In connection oriented networks, each packet 14 is labelled with a connection ID rather than an address. Address information is transferred to each node during a connection set-up phase, when an entry is added to each switching table in the network nodes. In connectionless networks 11, each packet 14 is labelled with a destination address, and may also be labelled with the sequence number of the packet 14. This can preclude the use for a dedicated path in the network 11 to help the packet 14 find its way to its destination. Each packet 14 is dispatched and may go via different routes. At the destination, the original message/data is reassembled in the correct order, based on the packet 14 sequence number. Thus a virtual connection, also known as a virtual circuit or byte stream is provided to the end-user by the transport layer 102 (see FIG. 3) protocol, although intermediate network nodes can provide a connectionless network layer service.

In terms of operation of the networks 11, this is implemented by third party network control entities and configured hardware (not shown), as is known in the art. These third party entities/hardware configure the network 11 as a third party network 11, over which the content transmitter 16 (and distribution server 20) has little to no control concerning the prioritization of the packets 14 communicated over the network 11. Network resources of the networks 11 are managed by the third party entities/hardware through statistical multiplexing or dynamic bandwidth allocation, in which a physical communication channel of the network 11 is effectively divided into an arbitrary number of logical variable-bit-rate channels or data streams. Each logical stream can consist of a sequence of packets 14, which normally are forwarded by one or more interconnected network nodes (not shown) of the network 11 asynchronously in a first-in, first-out fashion. Alternatively, the forwarded packets 14 may be organized by the third party entities/hardware according to some scheduling discipline for fair queuing and/or for differentiated or guaranteed quality of service. In case of a shared physical medium, the packets 14 may be delivered according to some packet-mode multiple access scheme. It is recognised that when traversing network 11 nodes, packets 14 can be buffered and queued, resulting in variable delay and throughput, depending on the traffic load in the network 11.

It is recognised that packet switching contrasts with another principal networking paradigm, circuit switching, a method which sets up a specific circuit with a limited number dedicated connection of constant bit rate and constant delay between nodes for exclusive use during the communication session. The service actually provided to the user by networks 11 using packet switching nodes can be either be connectionless (based on datagram messages), or virtual circuit switching (also known as connection oriented). Some connectionless protocols are Ethernet, IP, and UDP; connection oriented packet-switching protocols include X.25, Frame relay, Asynchronous Transfer Mode (ATM), Multiprotocol Label Switching (MPLS), and TCP.

In view of the above, it is recognized that generation (e.g. encoding) and manipulation (e.g. duplication via the distribution server 20, decoding by the decoder 22) of the packets 14 is implemented by the corresponding buffers 30,32,34 (see FIG. 2) of the corresponding network entities/nodes 16,20,22, according to the communication protocol(s) (e.g. TCP/IP) that the buffers are configured therewith (see FIG. 3 and corresponding description).

### Encoders—Decoders

Referring to FIG. 2, shown is a block diagram of the transmitter 16 with a plurality of encoders 25, the distribution server 20, and the plurality of receivers/decoders 22 at each of the remote facilities 17, where communication of the content 12,15 is done via the network 11. The application processes that communicate the content 12,15, as packets 14, can be defined as the encoder 25, the distribution engine 200 of the distribution server 20, and/or the decoder 22.

The video/audio content 13 (e.g. a video source) is received by the video transmitter 16 and then the streaming video encoders 25 encode (e.g. using an MPEG4 based encoding standard/algorithm) and then transmit the corresponding video signals 12 over the network 11 to the distribution server 20 and then ultimately to the video receivers (e.g. decoders 22), which then decode the corresponding encoded content 15 and display the video signal in real time on the displays 23 of the remote facilities 17. The receiver 22 uses on a configured decoder buffer 30 to receive the encoded video data packets 14 from the network 11 and to transfer the packets 14 to the video decoder 22.

The streaming video transmitter 16 also comprises the video frame source 13, the video encoders 25 and corresponding encoder buffers 32. The video frame source 13 may be any sequence of uncompressed video frames, communicated from production equipment of the sport venue 18, equipment such as but not limited to a television or satellite antenna and receiver unit, a video camera, a disk storage device capable of storing a “raw” video data, and the like.

Referring again to FIG. 2, the uncompressed video frames 13 enter the video encoders 25 at a given picture rate (or “streaming rate”) and are compressed according to any known compression algorithm or device, such as an MPEG-4 encoding standard. The video encoders 25 then transmit the compressed video frames 12 to their encoder buffer 32 for buffering in preparation for transmission across the data network 11 as a plurality of packets 14. The data network 11 may be any suitable IP network and may include portions of both public data networks, such as the Internet, and private data networks, such as an enterprise-owned local area network (LAN) or wide area network (WAN).

Streaming video receiver comprises a decoder buffer 30, a video decoder 22 and a coupled video display or displays 23. The decoder buffer 30 receives and stores streaming compressed video frames content 15 received from data network 11.

The decoder buffer 30 then transmits the compressed video frames content 15 to the video decoder 22, which then decompresses the video frames at the same rate (for example) at which the video frames were compressed by video encoder 25.

### Packets 14

Each packet 14 of the content 12,15 consists of two kinds of data: control information and user data (also known as payload). The control information provides data the network 11 uses to deliver the user data, for example: source and destination addresses, error detection codes like checksums, and sequencing information. Typically, the control information is found in packet headers and trailers, with user data (i.e. the video/audio content 12,15) in between.

It is recognised that different communications protocols of the buffers 30,32,34 can use different conventions for distinguishing between the elements and for formatting/manipulating the data. In Binary Synchronous Transmission, the packet 14 is formatted in 8-bit bytes, and special characters are used to delimit the different elements. Other protocols, like Ethernet, establish the start of the header and data elements by their location relative to the start of the packet 14. Some protocols can format/manipulate the information at a bit level instead of a byte level.

In general, the term packet 14 can apply to any message content 12,15 formatted in a packet 14, while the term datagram can be defined for packets 14 of an “unreliable” service. A “reliable” service can be defined as a service that notifies the user if packet 14 delivery fails, while an “unreliable” service does not notify the user if packet 14 delivery fails. For example, IP provides an unreliable service. Together, TCP and IP provide a reliable service, whereas UDP and IP provide an unreliable one. All these protocols use packets 14, but UDP packets 14 can be referred to as datagrams.

For example, IP packets 14 are composed of a header and payload (i.e. content 12,15 distributed over the individual packets). An IPv4 packet header consists of: 4 bits that contain the version, that specifies if it's an IPv4 or IPv6 packet; 4 bits that contain the Internet Header Length which is the length of the header in multiples of 4 bytes (e.g. 5 is equal to 20 bytes); 8 bits that contain the Type of Service, also referred to as Quality of Service (QoS), which describes what priority the packet 14 should have; 16 bits that contain the length of the packet 14 in bytes; 16 bits that contain an identification tag to help reconstruct the packet 14 from several fragments; 3 bits that contain a zero, a flag that says whether the packet 14 is allowed to be fragmented or not (e.g. DF: Don't fragment), and a flag to state whether more fragments of the packet 14 follow (e.g. MF: More Fragments); 13 bits that contain the fragment offset, a field to identify which fragment this packet 14 is attached to; 8 bits that contain the Time to live (TTL) which is the number of hops (router, computer or device along the network 11) the packet 14 is allowed to pass before it dies (for example, a packet 14 with a TTL of 16 will be allowed to go across 16 routers to get to its destination before it is discarded); 8 bits that contain the communication protocol (TCP, UDP, ICMP, etc. . . . ); 16 bits that contain the Header Checksum, a number used in error detection; and 32 bits that contain the source IP address (e.g. entity 16, 20); 32 bits that contain the destination address (e.g. entity 20, 22). After those, optional flags can be added of varied length, which can change based on the protocol used, then the data 12,15 that packet 14 carries is added. For example, an IP packet 14 has no trailer, however, an IP packet 14 is often carried as the payload inside an Ethernet frame, which has its own header and trailer.

In view of the above example definition of the packets 14, it is recognised that the packet 14 can be defined as a block of data (e.g. including content 12,15) with length that can vary between successive packets 14, ranging from 7 to 65,542 bytes, including the packet header, for example. The packetized data (i.e. content 12,15) are transmitted via frames, which can be fixed-length data blocks. The size of a frame, including frame header and control information, can range up to 2048 bytes, for example. Because packet 14 lengths can be variable but frame lengths can be fixed, packet 14 boundaries may not coincide with frame boundaries.

Further, it is recognised that many networks may not provide guarantees of delivery, non-duplication of packets 14, or in-order delivery of packets 14, e.g., the UDP protocol of the Internet 11. However, the TCP protocol (also UDP) layer a transport protocol on top of the packet 14 service that can provide such protection; e.g. the transport layer 102 (see FIG. 3).

### Network 11 Communication Protocols of the Buffers 30,32,34

The application processes can be defined as the encoder 25, the distribution engine 200 of the distribution server 20, and/or the decoder 22, which use their TCP/IP communication protocol configured buffers 32,34,30 to communicate the data content 12,15 as a series of packets 14 over the network 11.

The Internet Protocol Suite (commonly known as TCP/IP) is a set of communications protocols used for the Internet and other similar networks 11. It is named from two of the most important protocols in it: the Transmission Control Protocol (TCP) and the Internet Protocol (IP), which were the first two networking protocols defined in this network communication standard.

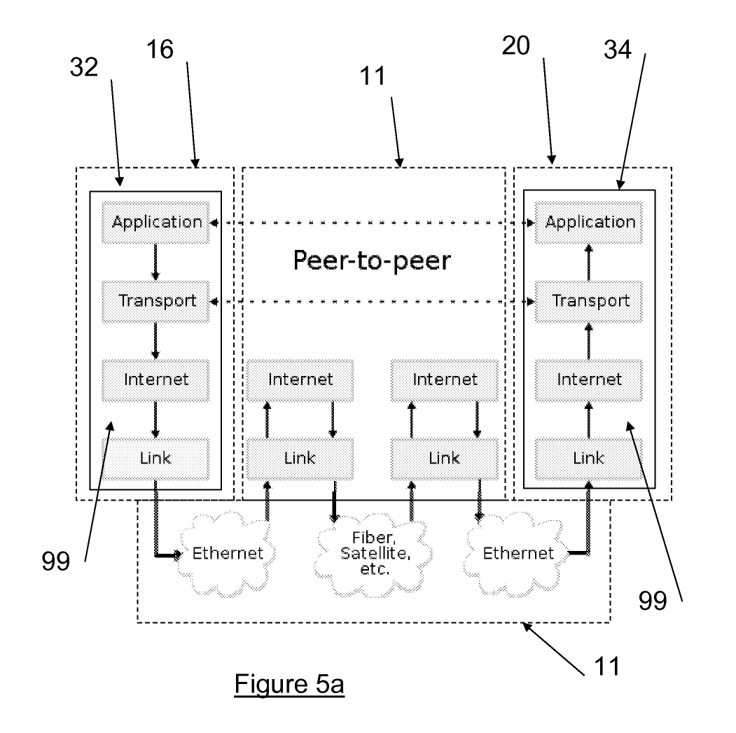

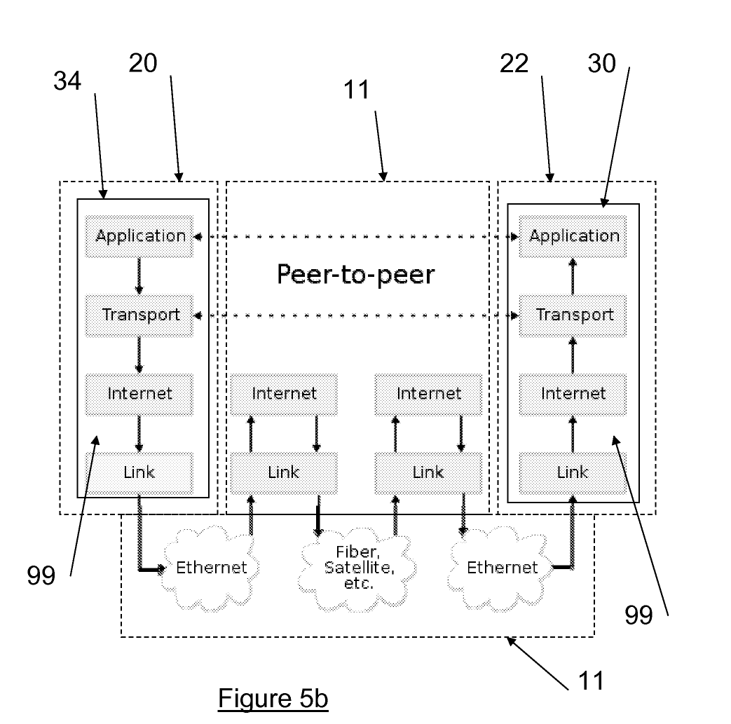

Referring to FIG. 3, the Internet Protocol Suite can be viewed as a set of layers 99 (e.g. the TCP/IP stack). The buffers 30,32,34 (see FIG. 5a,b) are configured to employ this layer/stack 99 arrangement, in order to generate/transmit or otherwise receive/manipulate the packets 14 containing the streaming data content 12,15. Each layer 99 solves a set of problems involving the transmission of the data content 12,15 as the packets 14, and provides a well-defined service to upper layer 99 protocols based on using services from some lower layers 99. Upper layers 99 are logically closer to the user and deal with more abstract data, relying on lower layer 99 protocols to translate data content 12,14 into forms (i.e. packets 14 that can eventually be physically transmitted over the network 11. The TCP/IP model can consists of four layers 99, from lowest to highest, these layers 99 are defined as a Link Layer 106, an Internet Layer 104, the Transport Layer 102, and the Application Layer 100. The TCP/IP suite uses encapsulation to provide abstraction of protocols and services. Such encapsulation usually is aligned with the division of the protocol suite into layers 99 of general functionality. In general, an application (the highest level of the model) uses a set of protocols to send its data down the layers 99, being further encapsulated at each level.

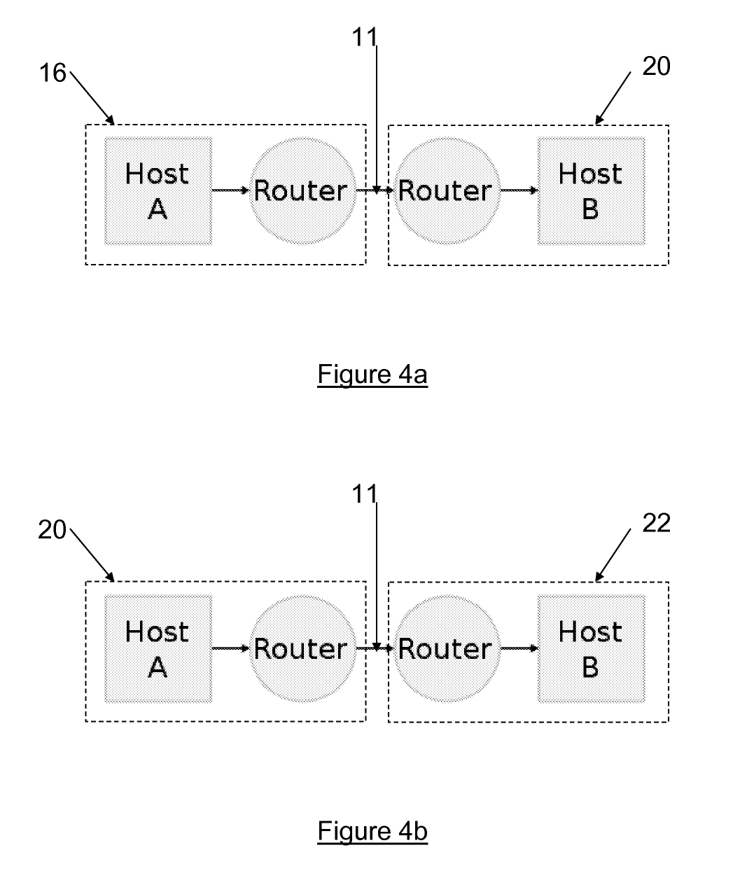

Referring to FIG. 4a, shown is an example network 11 connection scenario (e.g. between the transmitter 16 and the distribution server 20, in which the two Internet host computers 16,20 communicate across local network 11 boundaries constituted by their internetworking gateways (routers). Referring to FIG. 4b, shown is an example network 11 connection scenario (e.g. between the distribution server 20 and the receiver 22, in which the two Internet host computers 20,22 communicate across local network 11 boundaries constituted by their internetworking gateways (routers).

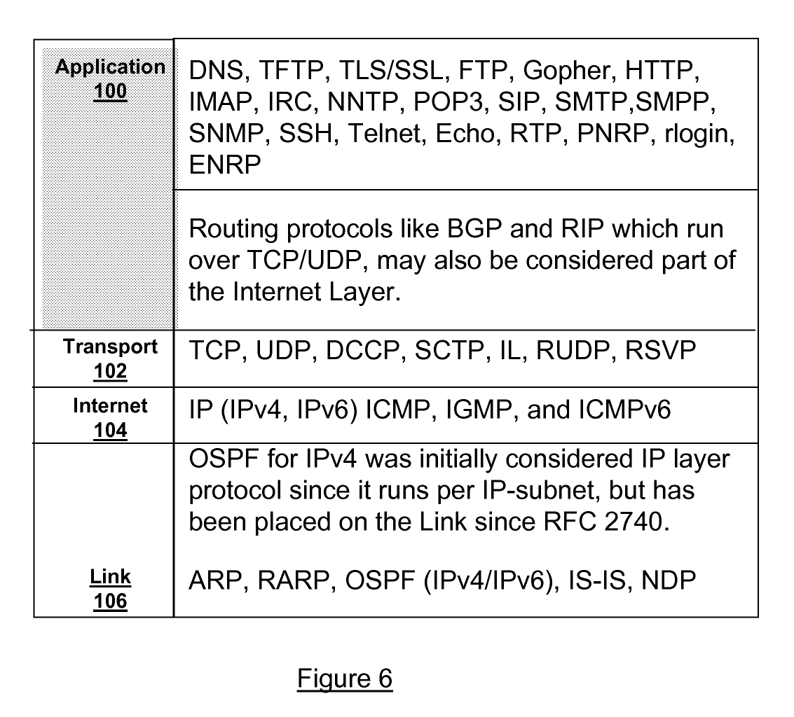

Referring to FIG. 5a, shown is an example stack connection corresponding to the network connection example of FIG. 4a. The TCP/IP stacks 99 are shown as operating on the two host computers 16, 20, as implemented in their corresponding buffers 32,34. The individual layers 100, 102, 104, 106, of the stacks 99, demonstrate by example the corresponding layers used at each hop (i.e. with routing a distance in terms of topology on the network 11 one hop can be defined as the step from one router to the next, on the path of the packet 14 on any communications network 11, such that the hop count then is the number of subsequent steps along the path from source—the network nodes 16,20, to the sink—the network nodes 20,22). Referring to FIG. 5b, shown is an example stack connection corresponding to the network connection example of FIG. 4b. The TCP/IP stacks 99 are shown as operating on the two host computers 20, 22, as implemented in their corresponding buffers 34,30. The individual layers 100, 102, 104, 106, of the stacks 99, demonstrate by example the corresponding layers used at each hop. Referring to FIG. 6, shown are some examples of the protocols grouped in their respective layers 99.

In view of the above, it is recognised that the Link Layer 106 (and the four-layer TCP/IP model) covers physical layer issues or an additional “hardware layer” (not shown) is assumed below the link layer 106. It is recognised that the Link Layer 106 can be defined as split into a Data Link Layer on top of a Physical Layer, as desired. It is recognised that the operating system OS of the computers 16,20,22 include and install a TCP/IP stack 99 by default. For example, TCP/IP stack 99 is included in all commercial Unix systems, Mac OS X, and all free-software Unix-like systems such as Linux distributions and BSD systems, as well as all Microsoft Windows operating systems.

### Sockets

An Internet 11 socket (or commonly, a network socket or socket), is a computer system software facility for the endpoint of bidirectional communication flow across an Internet Protocol based network 11, such as the Internet. The sockets can be defined as combining a local IP address and a port number (or service number) into a single identity. The defined socket is used by the applications 25,200,22 as an interface between the application 25,200,22 processes or thread and the IP protocol layer 104 of the stack 99 (see FIG. 3) provided by the operating system, and is allocated by application request as the first step in establishing data flow to another process or service.

The Internet socket can be identified by the operating system as a unique combination of the following: Protocol (TCP, UDP or raw IP); Local IP address; Local port number; Remote IP address (Only for established TCP sockets); and Remote port number (Only for established TCP sockets).

In view of the above, discussed is the difference between addressing at the level of the Internet Protocol (IP) (e.g. at the Internet layer 104), and addressing as it is seen by application processes (e.g. at the application layer 100). The application processes are defined as the encoder 25, the distribution engine 200 of the distribution server 20, and/or the decoder 22. To summarize, at layer 104, an IP address is assigned to the packet 14 for properly transmitting the data content 12,15 of the packet 14 between IP devices coupled over the network 11. In contrast, application protocols are concerned with a port assigned to each instance of the application, so they can correspondingly implement TCP or UDP.

It is recognised that the overall identification of an application process actually uses the combination of the IP address of the host it runs on—or the network interface over which it is talking, and the port number which has been assigned to it. This combined address is called a socket. Sockets can be specified using the following notation:<IP Address>/<Host Name>:<Port Number>. For example, if we have a Web site running on IP address 00.000.000.1, the socket corresponding to the HTTP server for that site would be 00.000.000.1:80. Accordingly, the overall identifier of a TCP/IP application process on a device is the combination of its IP address and port number, which is called a socket.

The operating system forwards incoming IP data packets to the corresponding application process by extracting the above socket address information from the IP, UDP and TCP headers. The combination of an IP address and a port number is referred to as a socket, such that communicating local and remote sockets are called socket pairs. For example, stream socket pairs, also known as connection-oriented socket pairs, use Transmission Control Protocol (TCP) or Stream Control Transmission Protocol (SCTP).

### Distribution Server 20

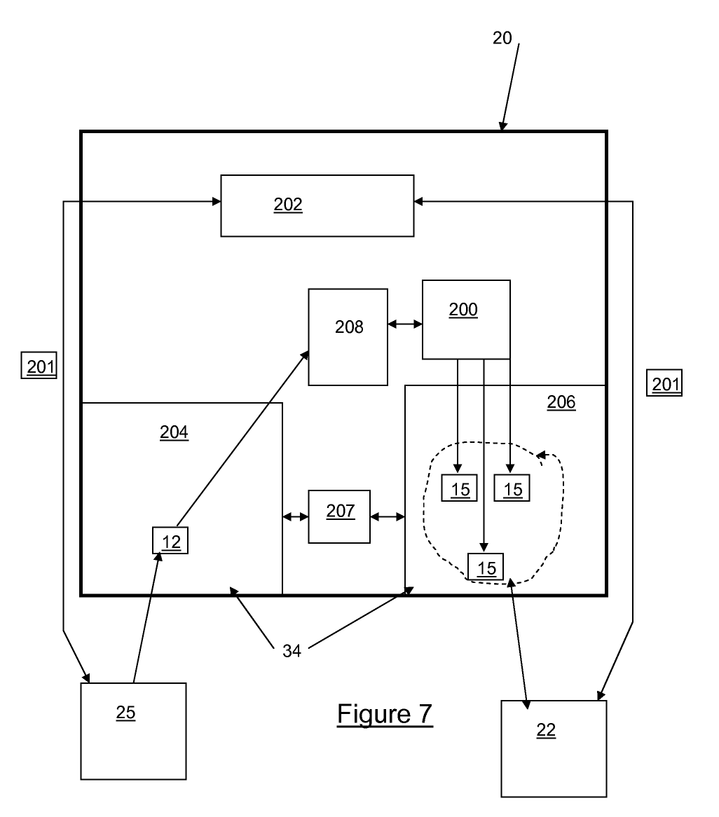

Referring to FIG. 7, shown is a block diagram of the distribution server 20. the distribution server 20 provides for controlled access to the encoded signals 12,15, by directing/duplicating the received content 12 over the network as content 15 to selected authorized decoders 22.

The distribution server 20 is configured for receiving/intercepting the transmitted video/audio content 12 from the transmitter 16 and for duplicating the content 12, via a duplication engine 200, as duplicated content 15 for feeding a plurality of receivers 22 simultaneously. The distribution server then transmits the content 15 to the selected decoders 22. In other words, the distribution server 20 is configured for distributing the received content 12 as duplicated content 15 in a one (e.g. encoder 25) to many (e.g. receiver 22) arrangement. Further, the distribution server 20 also has a monitoring engine 202 for monitoring the performance of the encoders 25 and decoders 22 of the environment 10. Further, the distribution server 20 also has a receive buffer 204 and a send buffer 206, of the buffer 34, such that the TCP/IP layers 99 of the buffers 204,206 are configured for interaction with the buffers 32 of the encoders and buffer 30 of the decoders 22 via buffer settings 208.

### Monitor Engine 202

The monitor engine 202 is configured for overseeing the uptime of the encoders 25 and decoders 22, so as to minimize signal quality issues and any downtime (e.g. lack of display of the originating content 13 on the displays 23) experienced by in the system 10.

The monitoring engine 202 receives or otherwise notes the absence of operation signals 201 from the encoders 25 and the corresponding (i.e. encoded content 12 matched to decoder configuration) decoders 22, such that the operation signals 201 provide to the monitoring engine 202 an indication of operational quality of the encoders 25 (e.g. the status of performance metrics of the encoding process) and decoders 22 (the status of performance metrics of the decoding process). These performance metrics can include metrics such as but not limited to: is the connection (e.g. socket) between the encoder 25 and the distribution server 20 alive; is the connection (e.g. socket) between the decoder 20 and the distribution server 20 alive; is there a delay in sending of the packets 14 over the network 11; is there a delay in the receiving of packets over the network 11; is the delay between send and receive of the packets 14 great than an acceptable predefined packet delay threshold; and is the loss of packets 14 between the encoder 25 and the paired decoder 22 greater than a predefined packet loss threshold.

In response to status/performance issues with any of the selected encoders 25/decoders 22, the monitoring engine 202 can use the signals/communications 201 to: switch an encoder-decoder pair in the event that the decoder 22 is not receiving the required quality (e.g. encoder operation problems, network packet 14 losses) and/or quantity (e.g. network packet 14 losses) of the decoded content 12,15 for presentation to the display 23 connected to the decoder 22, such that the monitoring engine 202 can facilitate a change in the buffer 30,32,34 settings to provide for a dynamic socket change between a newly selected encoder 25 from the plurality of encoders 25 of the transmitter 16 and the decoder 22; and monitor the execution of a script on the decoder 22 and/or on the encoder 25 when certain metrics exceed tolerances. An example of the monitoring script for the decoder 22 is as follows:

#!/bin/sh

(
sleep 5
while true ; do
if netstat -n -t -p | grep oiab 1>& /dev/null ; then

if grep “decoder error” /var/log/oiab/oiaberr.log ; then

(
FILE=“/var/log/oiab/oiab-err.$RANDOM”
touch $FILE
killall oiab
sleep 10

)
fi
sleep 5

else

(

killall oiab
sleep 20
)

fi

done
) &

For example, the monitoring script can be used to detect if there is a malfunctioning the operation status of the encoder 25 and/or decoder 22, and if so, then to shut down and restart the corresponding encoder 25 and/or decoder 22.

Further, the monitoring module 202 can be configured for changing socket settings between the send buffer 206 and a selected decoder buffer 30 of the plurality of decoder buffers 30 at the facilities 17, such that a change in the pairing between the encoder 25 and the destination decoder 22 is effected. It is recognised that the monitor module 202 would send the updated socket settings to the decoder, including any decoder parameter settings (for use in decoding of the encoded video stream 15), as needed. Further, the monitor module can be adapted to dynamically update/monitor the buffer size settings of the encoder buffer(s) 32 and/or the decoder buffer(s) 30. as needed, in order to maintain the data bit rate transfer of the encoded video stream 12,15 over the network 11 at a specified bit rate threshold and/or bit rate range threshold (e.g. about 1.2 Mbps, about 1.0 Mbps, about 1.5 Mbps, between 0.5 Mbps and 2.0 Mbps, between 0.5 Mbps and 1.5 Mbps, between 1.0 Mbps and 2.0 Mbps, between 1.0 Mbps and 1.5 Mbps, or between 1.5 Mbps and 2.0 Mbps, and over 2.0 Mbps).

For example, the monitor module 202 can send buffer size settings information 207 over the network 11 to the encoders 25 or the decoders 22, such that the buffer 34 settings are maintained as compatible with the buffer 30,32 settings, as desired.

### Distribution Engine 200

The distribution server also has the distribution engine 200 for multiplying the received content 12 data stream from one of the decoders 25 received in the receive buffer 204 for subsequent transmission from the send buffer 206 as a plurality of content 15 data streams to a plurality of corresponding decoders 25 at one or more remote facilities 17 (see FIG. 1). In this case, it is recognised that the distribution engine 200 provides for the setup and maintaining of a plurality of socket connections (via the configured buffer 206) for communicating the received encoded content 12 in a one to many (i.e. to a plurality of decoders 22 compatible with the encoding scheme used by the encoder 25 as well as authorized to receive the particular content 12 transmitted by the encoder 25) distribution model for the resultant duplicated streaming content 15 (i.e. a plurality of content streams 15 based on the content stream 12).

For example, the distribution engine 200 has a plurality of distribution buffer settings 207 used in establishing the sockets between the distribution server 20 and selected decodes 22, based on the authorization of selected decoders 22 to receive the content 12 representing a specified sporting venue 18 (e.g. races/events from a particular race track) and/or specified content 13 (e.g. selected races/events out of an race/event schedule) from the specified sporting venue 18. For example, a certain facility or certain facilities 17 may not have authorization (e.g. a contract between the sporting venue 18 and the facility 17) to receive certain content 13 (e.g. a selected race/event or series of races/events provided by the sporting venue 18), such that the selected content 13 is only authorized for receipt by certain facilities 17 (and their corresponding decoders 22) and is restricted from being received by certain other facilities 17 (and their corresponding decoders 22). The distribution server 20 can be used to direct/distribute the authorized received content 12 to the authorized one or more facilities 17 and can be used to restrict distribution of restricted received content 12 to the restricted one or more facilities 17, as provided in the buffer settings information 207. For example, the buffer settings information 207 can contain the allowed sockets between the distribution server 20 and selected decoders 22, based on the authorized/restricted status of the content 12 associated with selected encoders 25.

Accordingly, in view of the above, the distribution engine 200 and/or the monitoring engine 202 can be used by the distribution server 20 (via the buffer settings 207) in setting up and maintaining the distribution of a streamed content 12 from a selected encoder 25 as duplicated content 15 to a selected decoder 22, in view of network, encoder, decoder operational status/performance, as well as in view of the allowed/authorized content 15 available to the decoder 22 selected from the available content 12 provided by one or more of the encoders 25. It is recognised in view of the above that the distribution server 20 provides for the distribution of multiple contents 12 from one or more selected encoders 25 as distributed content 15 to one or more selected decoders 22. The mode of transmission of the content 15 from the send buffer 206 can be unicast or multicast, as desired.

### Reorder Module 208

The distribution server 20 can also have an optional reorder module 208, which monitors the collection of the delay transmitted duplicate packets 14 of the content 12 sent from the encoders 25. For example, the encoders 25 can place the duplicate packets 14 in a 1,5 delay positioning, such that the packet 14 in the “one” position of the content 12 stream is duplicated in the “five” position of the content 12 stream, thus providing for an intentional/defined transmission delay for the duplicate packets 12. This delay in duplicate packet 14 positioning in the stream 12 can help to account for collision packet 14 losses in the network 11. The reorder module 208 is configured for reordering the delayed duplicate packets 14 such that they are adjacent to one another or otherwise changed in their positioning in the content 15 stream (e.g. not separated by other non-related packets 14), for subsequent reception by the decoders 25. Accordingly, the reorder module 208 is responsible for changing the order of the duplicate packets 14 in the content stream 15, as compared to the order of the duplicate packets 14 in the content stream 12, so as to provide for a decrease in the intentional/defined transmission delay for the duplicate packets 14 as compared to that defined/provided in the content stream 12.

It is recognised that all of the duplicate packets 14 in the stream content 15 are sent on the network 11 to the same decoder 22, as defined in the TCP/IP socket setting between the decoder buffer 30 and the distribution server buffer 34.

### Buffer 34 Characteristics

For a TCP/IP socket connection (between the buffers 32,34 and between the buffers 34,30) the send and receive buffer sizes for the socket connections define the TCP transmit/receive window. For example, the TCP window throttles the transmission speed down to a level where congestion and data loss do not occur. The window specifies the amount of data content 12,15 that can be sent and not received before the send is interrupted. If too much data content 12,15 is sent, it overruns the buffer and interrupts the transfer. The mechanism that controls data content 12,15 transfer interruptions is referred to as flow control of the buffers 30,32,34. If the receive window size for TCP/IP buffers is too small, the receive window buffer can be overrun, and a flow control mechanism therefore stops the data content 12,15 transfer until the receive buffer is empty. Accordingly, each of the buffers 30,32,34 are configured in a coordinated fashion, so as to facilitate packet loss 14 on the network 11 to less than a predefined loss minimum, so as to provide for an acceptable quality of the viewed sporting actions on the display 23.

It is recognised that flow control can consume a significant amount of CPU time and result in additional network latency as a result of data content 12,15 transfer interruptions. Latency is a time delay between the moment something is initiated, and the moment one of its effects begins or becomes detectable. Low latency allows human-unnoticeable delays between an input being processed and the corresponding output providing real time characteristics. This can be especially important for Internet connections of the system 10 utilizing video streaming services. Latency in the packet-switched network 11 is measured either one-way (the time from the source sending a packet 14 to the destination receiving it), or round-trip (the one-way latency from source to destination plus the one-way latency from the destination back to the source). Round-trip latency is more often quoted, because it can be measured from a single point. Note that round trip latency can excludes the amount of time that a destination system spends processing the packet 14. Where precision is important, one-way latency for a link can be more strictly defined as the time from the start of packet 14 transmission to the start of packet 14 reception. The time from the start of packet 14 reception to the end of packet 14 reception is measured separately and called “Serialization Delay”. This definition of latency is independent of the link's throughput and the size of the packet 14, and is the absolute minimum delay possible with that link.

However, in a non-trivial network 11, a typical packet 14 will be forwarded over many links via many gateways, each of which will not begin to forward the packet 14 until it has been completely received. In such a network 11, the minimal latency is the sum of the minimum latency of each link, plus the transmission delay of each link except the final one, plus the forwarding latency of each gateway. In practice, this minimal latency is further augmented by queuing and processing delays. Queuing delay occurs when a gateway receives multiple packets 14 from different sources heading towards the same destination. Since typically only one packet 14 can be transmitted at a time, some of the packets 14 must queue for transmission, incurring additional delay. Processing delays are incurred while a gateway determines what to do with a newly received packet 14. The combination of propagation, serialization, queuing, and processing delays often produces a complex and variable network latency profile.

Accordingly, lone factor in helping to control the amount of latency in the system 10 is using buffer 30,32,34 socket settings. It is recognised that a larger buffer size can reduce the potential for flow control to occur, and can result in improved CPU utilization. However, a large buffer size can have a negative effect on performance in some cases. For example, if the TCP/IP buffers 30,32,34 are too large and applications (e.g. encoders 25, distribution server 20, deciders 22) are not processing data content 12,15 fast enough, paging can increase. The goal is to specify a value large enough to avoid flow control, but not so large that the buffer accumulates more data content 12,15 than the system (e.g. encoders 25, distribution server 20, deciders 22) can process.

Optimal buffer 30,32,34 settings can involve several network environment factors including types of switches and systems, acknowledgment timing, error rates and network topology, memory size, and data transfer size, as well as encoder 25 and decoder 22 operational performances. The settings in the buffers 30,32,34 are coordinated in order to reduce the amount of buffering used in transmit/receive of the content 12,15 with a corresponding acceptable data transfer rate of the content 12,15 between the encoders 25 and the decoders 22. The buffer 30,32,34 settings provide for a method of being able to transmit the content 12,15 of at least 1 Mbit/second (e.g. 1.2 Mbit/second) with drop outs, delays or pauses in the content 12,15 (as perceived by the decoder 25 and/or display 23) at or below corresponding predefined thresholds.

For example, overall latency of less than 10 seconds is obtained by the system 10 in order to meet minimum federal regulatory standards. The total time for transmission from the home track 18 to the transmitter 16 via satellite 21 (see FIG. 1) and retransmission from the transmitter 16 to the decoder 22 location via the Internet 11 is monitored to be less that a predefined overall latency threshold (e.g. less than 10 seconds). For example, the present system 10, as described, can have a latency for content 12,15 over the network 11 of less than 3 seconds from receipt of the content 13 and delivery of the content 15, for example.

Example setting for the buffer 34 of the distribution server 20 is as follows:

<PREF NAME=“reflector_bucket_offset_delay_msec” TYPE=“UInt32” >73</PREF>

| <PREF NAME=“reflector_buffer_size_sec” TYPE=“UInt32” >10</PREF> | | |
|---|---|---|
| <PREF | NAME=“reflector_use_in_packet_receive_time” | TYPE=“Bool16” |

>false</PREF>

| <PREF NAME=“reflector_in_packet_max_receive_sec” TYPE=“UInt32” >60</PREF> | | |
|---|---|---|
| <PREF NAME=“reflector_rtp_info_offset_msec” TYPE=“UInt32” >500</PREF> | | |
| <PREF NAME=“disable_rtp_play_info” TYPE=“Bool16” >false</PREF> | | |
| <PREF NAME=“allow_non_sdp_urls” TYPE=“Bool16” >true</PREF> | | |
| <PREF NAME=“enable_broadcast_announce” TYPE=“Bool16” >true</PREF> | | |
| <PREF NAME=“enable_broadcast_push” TYPE=“Bool16” >true</PREF> | | |
| <PREF | NAME=“max_broadcast_announce_duration_secs” | TYPE=“UInt32” |

>0</PREF>

<PREF NAME=“allow_duplicate_broadcasts” TYPE=“Bool16” >false</PREF>

Further, it is recognised that buffer 34 settings can be placed in an XML file hosted in the settings 207 that is used by the reorder module 208, for example, to control (e.g. via the buffer 34 size) the wait for any missing packets 14 received in the stream content 12 (e.g. when a duplicate packet 14 is missing from the stream content 12) prior to starting the reordering of the duplicate packets 14 when assembled into the streaming content 15.

### Encoder 25 and Decoder 22

The video system 10 includes a plurality of communication devices 16,20,22 and communication channels, e.g. the network 11, which provide the communication medium for the communication devices 16,20,22. For example, the communication channel may be wire line connections 11 or RF frequency carders 11. To increase the efficiency of the video system, video that needs to be communicated over the communication medium 11 is digitally compressed via the encoders 25. The digital compression algorithm (e.g. MPEG4) reduces the number of bits needed to represent the video while maintaining perceptual quality of the video in the content 12,15. The reduction in bits allows more efficient use of channel bandwidth and can reduce storage requirements for the transmission and reception of the content 12,15. The encoder 25 (e.g. the encoder engine) allows the communication device to compress video before transmission over the communication channel 11. The decoder 22 (e.g. the decoder engine) enables the communication device to receive and process compressed video content 15 from the communication channel 11.

Several standards for digital video compression exist, including International Telecommunications Union ITU-T Recommendation H.261, the International Standards Organization/International Electrotechnical Committee, ISO/IEC, 11172-2 International Standard, MPEG-1, MPEG-2, and MPEG 4. These standards designate the requirements for the decoder 22 by specifying the syntax of a bit stream that the decoder 22 must decode, for subsequent display of the video on the displays 23. This provides for some flexibility in the operation of the encoder 25, but the encoder 25 must be capable of producing a bit stream content 12 that meets the specified syntax as expected by the decoder 22.

To maximize usage of the available channel 11 bandwidth and the quality of the video content 12, the encoder 25 seeks to match the number of bits it produces to the available channel 11 bandwidth, including leveraging of the TCP/IP socket and buffer size settings as defined in the buffer 32. This can be done by selecting a target number of bits to be used for the representation of a video frame or picture 13 in the encoded content 12. The target number of bits is referred to as the target bit allocation. The target bit allocation may be substantially different from picture 13 to picture 13, based upon picture 13 type and other considerations. A further consideration for the encoder 25 in generating bits is the capacity of any buffers 30,32,34 in the system 10. Generally, since the bitrates of the encoder 25 and decoder 22 are not constant, as well as the data content 13 manipulation rate of the distribution server 20, there are buffers 32,30 placed at both ends of the channel 11, one following the encoder 25 prior to the channel 11 and one at the end of the channel 11 preceding the decoder 22, as well as one buffer 34 (e.g. buffers 204,206—see FIG. 7) in the channel 11 between the encoder 25 and decoder 22, i.e. at the distribution server 20. The buffers 30,32,34 are configured for performance in order to absorb the fluctuation in bitrates in send/receive operations of the contents 12,15. The encoder 25 can also be configured to operate such that the buffers 03,32,34 at the encoder 25, the distribution server 20 and the decoder 22 will not overflow or underflow as a result of the bit stream generated.

### Encoder 25

The encoder 25 is (e.g. encoder engine) used to change a signal (such as a bitstream) or data 13 into a code 12. The code 12 serves any of a number of purposes such as compressing information for transmission or storage, encrypting or adding redundancies/duplications to the input code 13, or translating from one code to another (e.g. from MPEG2 format of the satellite 21 content 13 to the MPEG4 format of the content 12 suitable for transmission over the shared network 11). This is done predominantly by means of a programmed algorithm (e.g. MPEG4 encoding algorithm), with any analog encoding done with analog circuitry where/if needed. The data 13 are encoded as content 12 (for ultimate consumption by a similarly configured decoder (30)—e.g. part of the CODEC of the encoder 25/decoder 22 pairing) to provide an output bit stream content 12 for transmission over the network 11 via the distribution server 20.

The streaming video transmitter 16 comprises the video frame source 13, the one or more video encoders 25 (e.g. at least one for each race/event content 13 received from the plurality of sporting venues 18) and the corresponding encoder buffers 32, see FIG. 2. Video frame source 13 may be any video from one or more devices capable of generating a sequence of uncompressed video frames, including a television/satellite antenna and receiver unit, a video cassette player, a video camera, a disk storage device capable of storing a “raw” video clip, and the like.

As discussed above, the uncompressed video frames 13 (e.g. uncompressed or otherwise in a compression format that is different from the compression format of the encoders 25) enter video encoder 25 at a given picture rate (or “streaming rate”) and are compressed according to the compression algorithm hosted on the encoder 25, such as an MPEG-4 encoding algorithm. The video encoder 25 then transmits the compressed video frames 12 to encoder buffer 32 for buffering in preparation for transmission across data network 11, according to the TCP/IP socket settings and buffer size settings defined for the buffer 32. The encoder 25 can also be configured to operate such that the buffers 03,32,34 at the encoder 25, the distribution server 20 and the decoder 22 will not overflow or underflow as a result of the bit stream generated.

Optionally, the encoders 25 can be configured to generate duplicate packets 14 (also referred to as packet mirroring) of the content 13 and to place the duplicate packets 14 into the stream content 12 in a predefined delay positioning arrangement (e.g. a 1,5 delay positioning), such that the packet 14 in the “one” position of the content 12 stream is duplicated in the “five” position of the content 12 stream, thus providing for an intentional/defined transmission delay for the duplicate packets 14. This delay in duplicate packet 14 positioning in the stream 12 can help to account for collision packet 14 losses in the network 11. It is recognised that all of the duplicate packets 14 in the stream content 12 are sent on the network 11 to the same distribution server 20, as defined in the TCP/IP socket setting between the encoder buffer 32 and the distribution server buffer 34.

In view of the multiple encoders 25 of the transmitter 18, all of the encoder outputs 12 are sent to the transmitter router (see FIG. 4a) and are then combined and sent as the signal IP stream 12 for receipt by the distribution server 20.

Further, it is recognised that the encoder engine 25 can be adapted to receive update buffer settings from the network 11, as sent by the distribution server 20, and also adapted to apply the update buffer settings to the encoder buffer 32.

### Encoder Buffer 32

For the TCP/IP socket connection (between the buffer 32 and the buffer 34) the send and receive buffer sizes for the socket connection defines the TCP transmit/receive window for content 12 communicated between the transmitter 18 and the distribution server 20. Accordingly, the TCP/IP buffer settings in the buffer 32 are compatible or otherwise configured in association with the TCP/IP buffer settings in the buffer 34. For example, the TCP window throttles the transmission speed down to a level where congestion and data loss do not occur. The window specifies the amount of data content 12 that can be sent and not received before the send is interrupted. If too much data content 12 is sent, it overruns the buffer 34 and interrupts the transfer. The mechanism that controls data content 12 transfer interruptions is referred to as flow control of the buffers 32. If the receive window size for TCP/IP buffers is too small, the receive window buffer 34 can be overrun, and a flow control mechanism therefore stops the data content 12 transfer until the receive buffer 34 is empty. Accordingly, each of the buffers 32,34 are configured in a coordinated fashion, so as to facilitate packet loss 14 on the network 11 of the content 12 to less than a predefined loss minimum, so as to provide for an acceptable quality of the viewed sporting actions on the display 23, once received and decoded by the decoder 22.

It is recognised that flow control can consume a significant amount of CPU time and result in additional network latency as a result of data content 12 transfer interruptions. Latency is a time delay between the moment something is initiated, and the moment one of its effects begins or becomes detectable. Low latency allows human-unnoticeable delays between an input being processed and the corresponding output providing real time characteristics. This can be especially important for Internet connections of the system 10 utilizing video streaming services. Latency in the packet-switched network 11 is measured either one-way (the time from the source 18 sending a packet 14 to the destination 20 receiving it), or round-trip (the one-way latency from source 18 to destination 20 plus the one-way latency from the destination 20 back to the source 18). Round-trip latency is more often quoted, because it can be measured from a single point. Note that round trip latency can excludes the amount of time that a destination 20 system spends processing the packet 14. Where precision is important, one-way latency for a link can be more strictly defined as the time from the start of packet 14 transmission to the start of packet 14 reception. The time from the start of packet 14 reception to the end of packet 14 reception can be measured separately and called “Serialization Delay”. This definition of latency is independent of the link's throughput and the size of the packet 14, and is the absolute minimum delay possible with that link.

However, in a non-trivial network 11, a typical packet 14 will be forwarded over many links via many gateways between the transmitter 18 and the distribution server 20, each of which will not begin to forward the packet 14 until it has been completely received. In such a network 11, the minimal latency is the sum of the minimum latency of each link, plus the transmission delay of each link except the final one, plus the forwarding latency of each gateway. In practice, this minimal latency is further augmented by queuing and processing delays. Queuing delay occurs when a gateway receives multiple packets 14 from different sources heading towards the same destination. Since typically only one packet 14 can be transmitted at a time, some of the packets 14 must queue for transmission, incurring additional delay. Processing delays are incurred while a gateway determines what to do with a newly received packet 14. The combination of propagation, serialization, queuing, and processing delays often produces a complex and variable network latency profile.

Accordingly, lone factor in helping to control the amount of latency in the system 10, between the encoders 25 and the distribution server 20, is using buffer 32,34 socket settings. It is recognised that a larger buffer size can reduce the potential for flow control to occur, and can result in improved CPU utilization. However, a large buffer size can have a negative effect on performance in some cases. For example, if the TCP/IP buffers 32,34 are too large and applications (e.g. encoders 25, distribution server 20) are not processing data content 12 fast enough, paging can increase. The goal is to specify a value large enough to avoid flow control, but not so large that the buffer accumulates more data content 12 than the system (e.g. encoders 25, distribution server 20) can process.

Optimal buffer 32,34 settings can involve several network environment factors including types of switches and systems, acknowledgment timing, error rates and network topology, memory size, and data transfer size, as well as encoder 25 and distribution server 20 operational performances. The settings in the buffers 32,34 are coordinated in order to reduce the amount of buffering used in transmit/receive of the content 12 with a corresponding acceptable data transfer rate of the content 12 between the encoders 25 and the distribution server 20. The buffer 32,34 settings provide for a method of being able to transmit the content 12 of at least 1 Mbit/second (e.g. 1.2 Mbit/second) with drop outs, delays or pauses in the content 12 (as eventually perceived by the decoder 25 and/or display 23) at or below corresponding predefined thresholds.

An example of the encoder buffer 32 settings is as follows, e.g. TCP/IP:

linkspeed and duplex 100 Mbps/Duplex Full

number of coalesce buffer 768

number of receive descriptors 2048

off load receive ip checksum off

off load receive tcp checksum off

offload transmit ip checksum off

offload transmit tcp checksum off

Qos packet tagging disabled

### Decoder 22

Streaming video receiver 22 (e.g. decoder engine) comprises decoder buffer 30, video decoder 22 and coupled to the video display 23. The decoder buffer 30 receives and stores streaming compressed video frames 15 from data network 11, as sent from the distribution server 20. Decoder buffer 30 then transmits the compressed video frames 15 to video decoder 22 as required. The video decoder 22 then decompresses the video frames 15 at the same rate (for example) at which the video frames 12 were compressed by video encoder 25.

In the event that the decoder 22 receives all of the duplicate packets 22 in the stream content 15, the decoder 22 can drop any identified duplicates 14 from the decoded content that is submitted to the displays 23. If no duplicates for a packet 14 are detected/received, then the decoder 22 uses the single received copy of the packet 14 for decoding and subsequent delivery to the display(s) 23.

The decoder 22 can be referred to as a Set Top Box, often abbreviated STB, which is an electronic device that is connected to the communication channel 11, and produces output for display on a conventional television screen 23. For example, set-top boxes 22 are used to receive and decode digital television broadcasts and to interface with the Internet 11. Set-top boxes can fall into several categories, from the simplest that receive and unscramble incoming television signals to the more complex that will also function as multimedia desktop computers that can run a variety of advanced services such as videoconferencing, home networking, IP telephony, video-on-demand (VoD) and high-speed Internet TV services.

Further, it is recognised that the decoder engine 22 can be adapted to receive update buffer settings from the network 11, as sent by the distribution server 20, and also adapted to apply the update buffer settings to the decoder buffer 30.

### Decoder Buffer 30

For the TCP/IP socket connection (between the buffer 34 and the buffer 30) the send and receive buffer sizes for the socket connection defines the TCP transmit/receive window for content 15 communicated between the distribution server 20 and the decoder 22. Accordingly, the TCP/IP buffer settings in the buffer 34 are compatible or otherwise configured in association with the TCP/IP buffer settings in the buffer 30. For example, the TCP window throttles the transmission speed down to a level where congestion and data loss do not occur. The window specifies the amount of data content 15 that can be sent and not received before the send is interrupted. If too much data content 15 is sent, it overruns the buffer 30 and interrupts the transfer. The mechanism that controls data content 15 transfer interruptions is referred to as flow control of the buffers 34. If the receive window size for TCP/IP buffers is too small, the receive window buffer 30 can be overrun, and a flow control mechanism therefore stops the data content 15 transfer until the receive buffer 30 is empty. Accordingly, each of the buffers 30,34 are configured in a coordinated fashion, so as to facilitate packet loss 14 on the network 11 of the content 15 (between the distribution server 20 and the decoders 22) to less than a predefined loss minimum, so as to provide for an acceptable quality of the viewed sporting actions on the display 23, once received and decoded by the decoder 22.

It is recognised that flow control can consume a significant amount of CPU time and result in additional network latency as a result of data content 15 transfer interruptions. Latency is a time delay between the moment something is initiated, and the moment one of its effects begins or becomes detectable. Low latency allows human-unnoticeable delays between an input being processed and the corresponding output providing real time characteristics. This can be especially important for Internet connections of the system 10 utilizing video streaming services. Latency in the packet-switched network 11 is measured either one-way (the time from the source 20 sending a packet 14 to the destination 22 receiving it), or round-trip (the one-way latency from source 20 to destination 22 plus the one-way latency from the destination 22 back to the source 20). Round-trip latency is more often quoted, because it can be measured from a single point. Note that round trip latency can excludes the amount of time that a destination 22 system spends processing the packet 14. Where precision is important, one-way latency for a link can be more strictly defined as the time from the start of packet 14 transmission to the start of packet 14 reception. The time from the start of packet 14 reception to the end of packet 14 reception can be measured separately and called “Serialization Delay”. This definition of latency is independent of the link's throughput and the size of the packet 14, and is the absolute minimum delay possible with that link.

However, in a non-trivial network 11, a typical packet 14 will be forwarded over many links via many gateways between the distribution server 20 and the decoders 22, each of which will not begin to forward the packet 14 until it has been completely received. In such a network 11, the minimal latency is the sum of the minimum latency of each link, plus the transmission delay of each link except the final one, plus the forwarding latency of each gateway. In practice, this minimal latency is further augmented by queuing and processing delays. Queuing delay occurs when a gateway receives multiple packets 14 from different sources heading towards the same destination. Since typically only one packet 14 can be transmitted at a time, some of the packets 14 must queue for transmission, incurring additional delay. Processing delays are incurred while a gateway determines what to do with a newly received packet 14. The combination of propagation, serialization, queuing, and processing delays often produces a complex and variable network latency profile.

Accordingly, lone factor in helping to control the amount of latency in the system 10, between the distribution server 20 and the decoders 22, is using buffer 30,34 socket settings. It is recognised that a larger buffer size can reduce the potential for flow control to occur, and can result in improved CPU utilization. However, a large buffer size can have a negative effect on performance in some cases. For example, if the TCP/IP buffers 30,34 are too large and applications (e.g. decoders 22, distribution server 20) are not processing data content 15 fast enough, paging can increase. The goal is to specify a value large enough to avoid flow control, but not so large that the buffer accumulates more data content 15 than the system (e.g. decoders 22, distribution server 20) can process.

Optimal buffer 30,34 settings can involve several network environment factors including types of switches and systems, acknowledgment timing, error rates and network topology, memory size, and data transfer size, as well as decoder 22 and distribution server 20 operational performances. The settings in the buffers 30,34 are coordinated in order to reduce the amount of buffering used in transmit/receive of the content 15 with a corresponding acceptable data transfer rate of the content 15 between the decoders 22 and the distribution server 20. The buffer 30,34 settings provide for a method of being able to transmit the content 15 of at least 1 Mbit/second (e.g. 1.2 Mbit/second) with drop outs, delays or pauses in the content 15 (as eventually perceived by the decoder 25 and/or display 23) at or below corresponding predefined thresholds.

In view of the above, it is recognised that the buffer 34 of the distribution server 20 has TCP/IP socket and buffer settings that are compatible with both the decoder buffer 30 and the encoder buffer 32, as the distribution server is used in the system 10 to coordinate the distribution of the encoded content 12 from the encoder(s) 25 to the selected/designated decoders 25 of the facilities, as defined in the settings information 207 (see FIG. 7).

An example of the encoder buffer 32 settings is as follows, e.g. TCP/IP:

net.ipv4.conf.all.rp_filter=0

net.ipv4.icmp_echo_ignore_broadcasts=0

net.ipv4.icmp_echo_ignore_all=0

net.ipv4.conf.all.log_martians=0

kernel.sysrq=1

net.core.rmem_max=524288

net.core.wmem_max=524288

net.ipv4.tcp_rmem=4096 50000000 5000000

net.ipv4.tcp_wmem=4096 65536 5000000

### CODEC Algorithm Used for Encoding/Decoding

MPEG refers to Motion Pictures Experts Group. MPEG-2 is a group of coding standards for digital audio and video, agreed upon by Moving Pictures Experts Group (MPEG). MPEG-2 can be used to encode audio and video for broadcast signals, including direct broadcast 13 satellite and network video 12,15. Systems part (part 1) defines Transport Stream to carry digital video and audio over somewhat-unreliable media, and are used in broadcast applications. The Video part (part 2) provides support for interlaced video. The MPEG-2 Audio part (Part 3) enhances MPEG-1's audio by allowing the coding of audio programs with more than two channels. In MPEG-2 AAC (Part 7), audio can alternatively be coded in a non-backwards-compatible way, which allows encoders to make better use of available bandwidth.

MPEG-4 is a video CODEC for web (streaming media) and CD distribution, conversational (videophone), and broadcast television. MPEG4 algorithms compress data to form small bits 12,15 that can be transmitted over the network 11 and then decompressed. MPEG4 achieves its compression rate by storing only the changes from one frame to another, instead of each entire frame. The video information is then encoded using a technique called Discrete Cosine Transform (DCT). MPEG4 uses a type of lossy compression, since some data is removed, but the diminishment of data is generally imperceptible to the human eye. Wavelet-based MPEG-4 files can be smaller than JPEG or QuickTime files, so they are designed to transmit video and images over a narrower bandwidth and can mix video with text, graphics and 2-D and 3-D animation layers as contained in the content 12,15. MPEG-4 defines how multimedia streams (video, audio, text and data) are transmitted as individual objects, and is designed to play streaming media file with quality.

MPEG-4 has features such as (extended) VRML support for 3D rendering, object-oriented composite files (including audio, video and VRML objects), support for externally-specified Digital Rights Management and various types of interactivity. MPEG-4 consists of several standards termed “parts”. Profiles are also defined within the individual “parts”, so an implementation of a part is ordinarily not an implementation of an entire part. The parts of MPEG4 used for the encoding of the content 12 in the system 10 include parts such as but not limited to: Part 2 ISO/IEC 14496-2, compression codec for visual data (video, still textures, synthetic images, etc.). One of the many “profiles” in Part 2 is the Advanced Simple Profile (ASP); and Part 3 ISO/IEC 14496-3, a set of compression codecs for perceptual coding of audio signals, including some variations of Advanced Audio Coding (AAC) as well as other audio/speech coding tools. There is also another CODEC called H.264 or MPEG4 part 10, that provides for even smaller sizes and even better quality at that size for the content 12,15, however, the current system 10 is not configured for use of the H.264 or MPEG4 part 10 encoding standard.

It is recognised that the system 10 could also use the encoding standard MPEG-47, which can be defined as a combination of MPEG-4 and MPEG-7, which refers to use MPEG-4 to do the content CODEC and distribution and use MPEG-7 to facilitate the distribution with metadata. MPEG-7 is a multimedia content description standard defined by Moving Picture Experts Group (MPEG). It is different from other MPEG CODEC standards like MPEG-1, MPEG-2 and MPEG-4, as MPEG7 uses XML to store metadata, and can be attached to time code in order to tag particular events, or synchronise lyrics to a song.

### Computer Devices 101

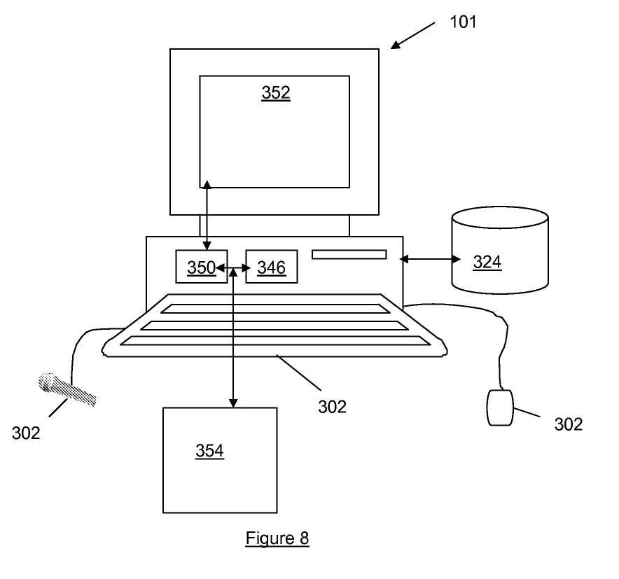

Referring to FIG. 8, shown is an example computing device 101 for use in hosting the transmitter 18 and the plurality of encoders 25, the distribution server 20, and the decoders 22, see FIG. 1. It is recognised that more than one computing device 101 can be used to host any of the network entities 18 (with encoders 25), 20, 22, as coupled via to one another via the network 11.

Referring to FIG. 8, the generic electronic device 101 can include input devices 302, such as a keyboard, microphone, mouse and/or touch screen by which the user interacts with the visual interface 302. It will also be appreciated that one or more of the network entities 18 (with encoders 25), 20, 22 reside on an electronic device 101, for example as separate devices 101 for the entity 18, the entity 20, and devices for one or more of the entities 20, for example. A processor 350 can co-ordinate through applicable software the entry of data and requests into the memory 324 and then display the results on a screen 352 (e.g. the display 23 in the case of the entity 22). A storage medium 346 can also be connected to device 101, wherein software instructions and/or member data is stored for use by the encoders 25, buffers 32, modules of the distribution server 20, buffer 34, and/or the decoder 22 and buffer 30, as configured. As shown, the device 101 also includes a network connection interface 354 for communicating over the network 11 with other components of the environment 10 (see FIG. 1), e.g. the distribution server 20 can communicate with the encoders 25/decoders 22, the transmitter 18 can communicate with the satellites 21 or other devices for use in obtaining the content 13 for use in subsequent encoding into the content 12.

The stored instructions on the memory 324 can comprise code and/or machine readable instructions for implementing predetermined functions/operations including those of an operating system, the buffers 30,32,34, the encoders 25, the decoders 22, or the distribution server 20 configuration, or other information processing system, for example, in response to commands or inputs provided by a user of the device 101. The processor 350 (also referred to as module(s)/engines for specific components/entities of the system 10) as used herein is a configured device and/or set of machine-readable instructions for performing operations as described by example above.

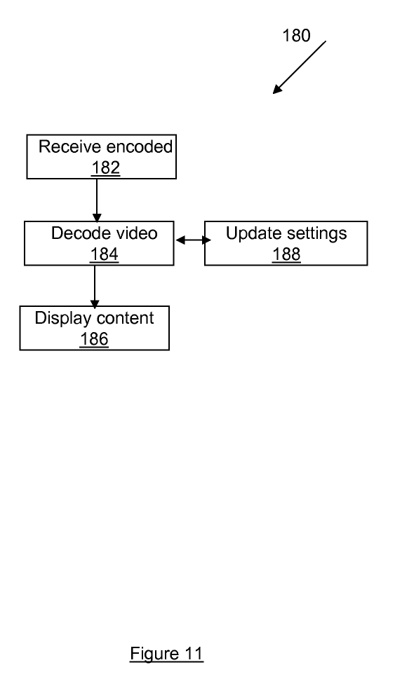

As used herein, the processor/modules/engines in general may comprise any one or combination of, hardware, firmware, and/or software. The processor/modules act upon information by manipulating, analyzing, modifying, converting or transmitting information for use by an executable procedure or an information device, and/or by routing the information with respect to an output device. The processor/modules may use or comprise the capabilities of a controller or microprocessor, for example. Accordingly, any of the functionality provided by the systems and processes of FIGS. 1-11 may be implemented in hardware, software or a combination of both. Accordingly, the use of a processor/modules as a device and/or as a set of machine readable instructions is hereafter referred to generically as a processor/module for sake of simplicity. It is recognised that the encoder 25 and decoder 22 functionality is predominantly expressed in software, for example.

It will be understood by a person skilled in the art that the memory 324 storage described herein is the place where data is held in an electromagnetic or optical form for access by a computer processor. In one embodiment, storage 324 means the devices and data connected to the computer through input/output operations such as hard disk and tape systems and other forms of storage not including computer memory and other in-computer storage. In a second embodiment, in a more formal usage, storage 324 is divided into: (1) primary storage, which holds data in memory (sometimes called random access memory or RAM) and other “built-in” devices such as the processor's L1 cache, and (2) secondary storage, which holds data on hard disks, tapes, and other devices requiring input/output operations. Primary storage can be much faster to access than secondary storage because of the proximity of the storage to the processor or because of the nature of the storage devices. On the other hand, secondary storage can hold much more data than primary storage. In addition to RAM, primary storage includes read-only memory (ROM) and L1 and L2 cache memory. In addition to hard disks, secondary storage includes a range of device types and technologies, including diskettes, Zip drives, redundant array of independent disks (RAID) systems, and holographic storage. Devices that hold storage are collectively known as storage media.

### Memory 324

The memory 324 (e.g. a buffer, main memory, etc.) is a further embodiment of memory as a collection of information that is organized so that it can easily be accessed, managed, and updated. In one view, databases can be classified according to types of content: bibliographic, full-text, numeric, and images. In computing, databases are sometimes classified according to their organizational approach. As well, a relational database is a tabular database in which data is defined so that it can be reorganized and accessed in a number of different ways. A distributed database is one that can be dispersed or replicated among different points in a network. An object-oriented programming database is one that is congruent with the data defined in object classes and subclasses.

Computer memory 324 typically contain aggregations of data records or files, such as sales transactions, product catalogs and inventories, and customer profiles. Typically, a database manager provides users the capabilities of controlling read/write access, specifying report generation, and analyzing usage. Databases and database managers are prevalent in large mainframe systems, but are also present in smaller distributed workstation and mid-range systems such as the AS/400 and on personal computers. SQL (Structured Query Language) is a standard language for making interactive queries from and updating a database such as IBM's DB2, Microsoft's Access, and database products from Oracle, Sybase, and Computer Associates.

Memory storage is the electronic holding place for instructions and data that the computer's microprocessor 350 can reach. When the computer 101 is in normal operation, its memory 324 usually contains the main parts of the operating system and some or all of the application programs and related data that are being used. Memory is often used as a shorter synonym for random access memory (RAM). This kind of memory is located on one or more microchips that are physically close to the microprocessor in the computer.

### Example Operation 140 of the Distribution Server 20

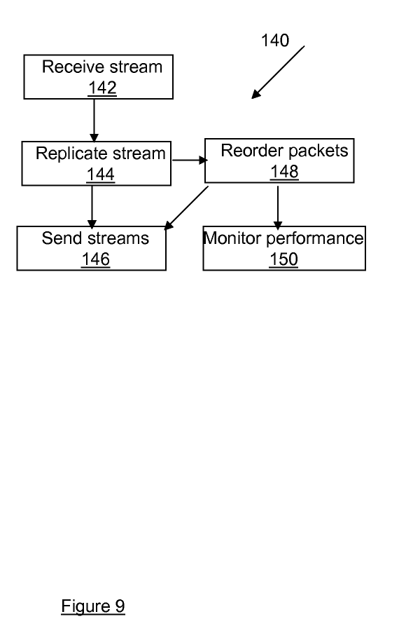

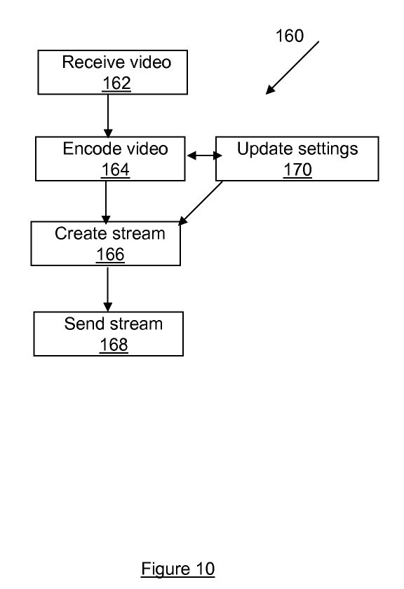

Referring to FIGS. 1 and 9, shown is an example operation 140 of the distribution server 20 for distributing encoded video content 12,15 over the public/shared packet-based communication network 11 to a plurality of decoders 22. At step 142, the receive buffer 204 receives the encoded video stream 12 from the network 11 as a plurality of packets 14, such that the receive buffer 32 has first receive buffer settings compatible with second receive buffer settings associated with the encoder buffer 32 being the origin of the encoded video stream 12. At step 144, the distribution module 200 replicates the encoded video stream 12 as a plurality of encoded video streams 15. At step 146, the send buffer 206 sends the plurality of video streams 15 over the network 11, such that a first replicated encoded video stream 15 of the plurality of video streams 15 being configured for sending to a first decoder buffer 30 and a second replicated encoded video stream 15 of the plurality of video streams 15 being configured for sending to a second decoder buffer 30 different from the first decoder buffer 30 (e.g. at different facilities 17). It is recognised that the send buffer 206 has first send buffer settings compatible with second send buffer settings associated with the first decoder buffer 30 being the destination of the first encoded video stream 15 and has third send buffer settings compatible with fourth send buffer settings associated with the second decoder buffer 30 being the destination of the second encoded video stream 15.

Further, as step 148, optionally the reorder module 208 reorders the duplicate packets 14 in the plurality of video streams 15. Also, at step 150, optionally, the monitor module 202 monitors the performance status of the encoders 25 and/or the decoders 22, as well as potentially sending update settings data 207 to the encoders 25 and/or the decoders 22, so as to maintain or otherwise amend the bit transfer rate of the encoded video stream 12,15 over the network 11.

### Example Operation 160 of the Encoder 25

Referring to FIGS. 1, 2, and 10, shown is an example operation 160 of the encoder 25 for sending encoded video 12 over the public/shared packet-based communication network 11 to the distribution server 20. At step 162, the encoder engine 25 receives the video content 13 from the sports venue(s) 18 and at step 164 encodes the received video content 13 as encoded video content using a predefined encoding algorithm. At step 166, the send buffer 32 configures the encoded content as an encoded video stream 12 expressed as a plurality of packets 14 for transmitting over the network 11. The send buffer has send buffer settings compatible with receive buffer 204 settings associated with the distribution server 20 such that the distribution server 20 is adapted for subsequent distribution of the encoded video stream 12,15 over the network 11 to the decoders 22 having the algorithm for use in decoding of the encoded video stream 15, such that the socket configuration is between the send buffer 32 of the encoder 25 and the receive buffer 204 of the distribution server 20. At step 168 the send buffer 32 sends the encoded stream 12 to the distribution server 20, sa per the defined socket settings of the buffer 32. Further, at step 170, optionally, the encoder engine 25 receives update buffer settings from the network 11 and applies the update buffer settings to the send buffer 32, so as to provide/maintain compatibility between the buffers 32,34.

### Example Operation 180 of the Decoder 22

Referring to FIGS. 1, 2, and 11, shown is an example operation 180 of the decoder 22 for receiving encoded video 15 over the public packet-based communication network 11 from the distribution server 20. At step 182, the receive buffer 30 receives the encoded content 15 as the encoded video stream 15 expressed as the plurality of packets 14, the receive buffer 30 has receive buffer settings compatible with send buffer settings associated with the distribution server 20, such that the distribution server 20 is adapted for distribution of the encoded video stream 15 over the network 11 to the decoder 22 that has the algorithm for use in decoding of the encoded video stream 15. The defined socket configuration is between the receive buffer 30 of the decoder 22 and the send buffer 206 of the distribution server 20. At step 184, the decoder engine 22 decodes the received encoded video content 15 as a decoded video content using the predefined decoding algorithm, and at step 186, the send buffer sends the decoded video stream to the display 23 for viewing, wherein the origination of the encoded video stream 15 is the encoder buffer 32 coupled to the receive buffer 204 of the distribution server 20. At step 188, optionally, the decoder engine 22 receives update buffer settings from the network 11 and applies the update buffer settings to the receive buffer 30, so as to provide/maintain compatibility between the buffers 30,34.

The term “about,” as used herein, should generally be understood to refer to both numbers in a range of numerals. Moreover, all numerical ranges herein should be understood to include each whole integer within the range.

It is to be understood that the invention is not to be limited to the exact configuration as illustrated and described herein. Accordingly, all expedient modifications readily attainable by one of ordinary skill in the art from the disclosure set forth herein, or by routine experimentation therefrom, are deemed to be within the spirit and scope of the invention as defined by the appended claims.

What is claimed is:

1. An encoder for sending encoded video over a public packet-based communication network to a distribution server, the encoder comprising:
an encoder engine adapted for receiving video content and adapted for encoding the received video content as an encoded video content using a predefined encoding algorithm;
a send buffer adapted for configuring the encoded content as an encoded video stream expressed as a plurality of packets for transmitting over the network, the send buffer having send buffer settings compatible with receive buffer settings associated with the distribution server such that the distribution server is adapted for subsequent distribution of the encoded video stream over the network to a decoder having the algorithm for use in decoding of the encoded video stream such that the socket configuration is between the send buffer of the encoder and the receive buffer of the distribution server.

2. The encoder of claim 1, wherein the buffer settings of the buffers are selected from the group comprising: buffer sizing; and socket definitions.

3. The encoder of claim 2, wherein the buffer settings are for a (Transmission Control Protocol/Internet Protocol) TCP/IP communication protocol.

4. The encoder of claim 3, wherein the algorithm is MPEG4 without part 11.

5. The encoder of claim 2, wherein the encoder engine is adapted to receive update buffer settings from the network and to apply the update buffer settings to the send buffer.

6. A method for sending encoded video over a public packet-based communication network to a distribution server, the method comprising instructions stored in a memory for execution by a computer processor, the instructions comprising:
receiving video content and adapted for encoding the received video content as an encoded video content using a predefined encoding algorithm; and
configuring the encoded content as an encoded video stream expressed as a plurality of packets for transmitting over the network, the send buffer having send buffer settings compatible with receive buffer settings associated with the distribution server such that the distribution server is adapted for subsequent distribution of the encoded video stream over the network to a decoder having the algorithm for use in decoding of the encoded video stream such that the socket configuration is between the send buffer of the encoder and the receive buffer of the distribution server.

7. The method of claim 6, wherein the buffer settings of the buffers are selected from the group comprising: buffer sizing; and socket definitions.

8. The method of claim 7, wherein the buffer settings are for a (Transmission Control Protocol/Internet Protocol) TCP/IP communication protocol.

9. The method of claim 8, wherein the algorithm is MPEG4 without part 11.

10. The method of claim 7 further comprising the instructions of receiving update buffer settings from the network and applying the update buffer settings to the send buffer.

11. A decoder for receiving encoded video over a public packet-based communication network from a distribution server, the decoder comprising:
a receive buffer adapted for receiving the encoded content as an encoded video stream expressed as a plurality of packets, the receive buffer having receive buffer settings compatible with send buffer settings associated with the distribution server such that the distribution server is adapted for distribution of the encoded video stream over the network to the decoder having the algorithm for use in decoding of the encoded video stream, such that the socket configuration is between the receive buffer of the decoder and the send buffer of the distribution server;
a decoder engine adapted decoding the received encoded video content as a decoded video content using a predefined decoding algorithm; and
a send buffer of the decoder adapted for sending the decoded video stream to a display for viewing;
wherein the origination of the encoded video stream is an encoder buffer coupled to a receive buffer of the distribution server.

12. The decoder of claim 11, wherein the buffer settings of the buffers are selected from the group comprising: buffer sizing; and socket definitions.

13. The decoder of claim 12, wherein the buffer settings are for a (Transmission Control Protocol/Internet Protocol) TCP/IP communication protocol.

14. The decoder of claim 13, wherein the algorithm is MPEG4 without part 11.

15. The decoder of claim 12, wherein the decoder engine is adapted to receive update buffer settings from the network and to apply the update buffer settings to the receive buffer.

16. A method for receiving encoded video over a public packet-based communication network from a distribution server, the method comprising instructions stored in a memory for execution by a computer processor, the instructions comprising:
receiving the encoded content as an encoded video stream expressed as a plurality of packets, the receive buffer having receive buffer settings compatible with send buffer settings associated with the distribution server such that the distribution server is adapted for distribution of the encoded video stream over the network to the decoder having the algorithm for use in decoding of the encoded video stream, such that the socket configuration is between the receive buffer of the decoder and the send buffer of the distribution server;
decoding the received encoded video content as a decoded video content using a predefined decoding algorithm; and
sending the decoded video stream to a display for viewing;
wherein the origination of the encoded video stream is an encoder buffer coupled to a receive buffer of the distribution server.

17. The method of claim 15, wherein the buffer settings of the buffers are selected from the group comprising: buffer sizing; and socket definitions.

18. The method of claim 17, wherein the buffer settings are for a (Transmission Control Protocol/Internet Protocol) TCP/IP communication protocol.

19. The method of claim 18, wherein the algorithm is MPEG4 without part 11.

20. The method of claim 17, further comprising the instruction of receiving update buffer settings from the network and applying the update buffer settings to the receive buffer.

21. The method of claim 16, wherein the update buffer settings are for providing a bit transfer rate of the decoded video stream from about 0.5 to 2 Mbps.
